(19) United States
(12) Patent Application Publication
(10) Pub. No.: US 2016/0264006 A1
(43) Pub. Date: Sep. 15, 2016

(54) HYBRID ELECTRICAL POWER SYSTEM FOR INDUSTRIAL ELECTRIC VEHICLE AND METHOD OF OPERATION THEREOF

(71) Applicant: M-field Energy LTD., Taipei City (TW)

(72) Inventors: TING-KAI CHOU, Taipei (TW); CHE-PING CHOU, Taipei (TW); CHEN-SHENG LIN, Taipei (TW); CHIH-PIN HSU, Taipei (TW)

(21) Appl. No.: 14/641,670

(22) Filed: Mar. 9, 2015

(51) Int. Cl. B60L 11/18; H02M 3/04

(52) U.S. Cl. CPC B60L 11/18; H02M 3/04

(57) ABSTRACT

A hybrid electrical power system for an electric vehicle, particularly an industrial electric vehicle such as an electric forklift, comprises a fuel cell stack, a DC/DC converter and a Li-ion battery. The DC/DC converter comprises a transformer for converting a voltage of direct current generated by the fuel cell stack to another voltage, and a controller for generating a reference voltage for the another voltage to approach. When the reference voltage is set to be larger than the another voltage, the fuel cell stack provides power to drive the vehicle and charge the Li-ion battery. When the reference voltage is set to be not larger than the voltage of direct current from the Li-ion battery, both the Li-ion battery and the fuel cell stack provide power to drive the vehicle.

### CROSS-REFERENCE TO RELATED APPLICATIONS

This application is related to co-pending patent application Ser. No. ______, entitled “HYBRID ELECTRICAL POWER SYSTEM FOR INDUSTRIAL ELECTRIC VEHICLE” and having an attorney docket number “US57957”, and co-pending application Ser. No. ______, entitled “FUEL CELL SYSTEM FOR INDUSTRIAL ELECTRIC VEHICLE” and having an attorney docket number “US57959.” The two co-pending applications are assigned to the same assignee as the present application and have the same filing date as the present application. The disclosures of the two co-pending applications are incorporated herein by reference.

### FIELD

The present disclosure relates to a hybrid electrical power system for use in a vehicle, and particularly to a hybrid electrical power system for use in an industrial electric vehicle such as a forklift. The present disclosure also relates to a method of an operation of the hybrid electrical power system.

### BACKGROUND

The currently commercial industrial electric vehicle, such as an electric forklift is powered by lead-acid batteries. The disadvantage of the lead-acid battery is that it has a limited operation time and needs a long recharging period. The lead-acid battery can only be charged at 0.2 C (charge rate), which means that once the battery is depleted, it will take 6-8 hours to recharge to its fully charged state. Accordingly, in a warehouse which has a non-stop operation, it usually needs to prepare two or three additional sets of battery for one electric forklift.

To overcome the disadvantage of the lead-acid battery, Li-ion batteries were introduced, which have the advantage of high charge rate of 1 C. Such advantage greatly reduces the lengthy recharge time. However, the Li-ion battery cannot afford stable power density during the period of its output. The voltage drops quickly after 40% State of Charge (SOC). This results in a slower movement of the electric forklift. The slow movement or the one-hour charging time of the forklift powered by Li-ion battery may be acceptable for a small warehouse. However, for a large warehouse speed and equipment utilization rate are important.

U.S. Pat. No. 4,961,151 to Early et al. discloses a fuel cell/battery hybrid power system which has a microprocessor based control system. The control system enables the fuel cell to be taken out of the system by a switch when its predetermined maximum desired energy output is about to be exceeded by load requirements. Furthermore, the battery thereof is protected from overcharging. US Pat. Appl. Pub. No. 2013/0108895 A1 to Van Werkhoven discloses a hybrid electrical power system having a fuel cell stack and an energy storage device. The system has a controller which controls an amount of an oxidant supply to the fuel cell stack on the demand by the load device. US Pat. Appl. Pub. 2013/0157157 A1 to Skidmore et al. discloses a method of operation of a hybrid power system including a fuel cell stack and an energy storage device. The method includes using a system controller to obtain information from the fuel cell stack and the energy storage device, and using the information to control an operation of the load device. U.S. Pat. No. 8,071,245 to Kajiwara discloses a system and method for balancing charge and discharge of the electric power storage device by changing amount of electric power consumed by the load portion by reducing a difference between the supply power set value and the actually supplied electric power value from the electric power storage device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is block diagram showing a hybrid electrical power system in accordance with the present disclosure, which is in electrical connection with a load of a vehicle.

FIG. 2 is a block diagram showing a schematic of a DC/DC converter of the hybrid electrical power system of FIG. 1.

FIG. 3 is a view similar to FIG. 1, showing the system operated in a first mode.

FIG. 4 is a view similar to FIG. 1, showing the system operated in a second mode.

FIG. 5 is a view similar to FIG. 1, showing the system operated in a third mode.

FIG. 6 is a view similar to FIG. 1, showing the system operated in a fourth mode.

FIG. 7 is a view similar to FIG. 1, showing the system operated in a fifth mode.

FIG. 8 is a flow chart of a method of an operation of the hybrid electrical power system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to a hybrid electrical power system for use in a vehicle, particularly an industrial electric vehicle such as an electric forklift, and a method of an operation of the hybrid electrical power system.

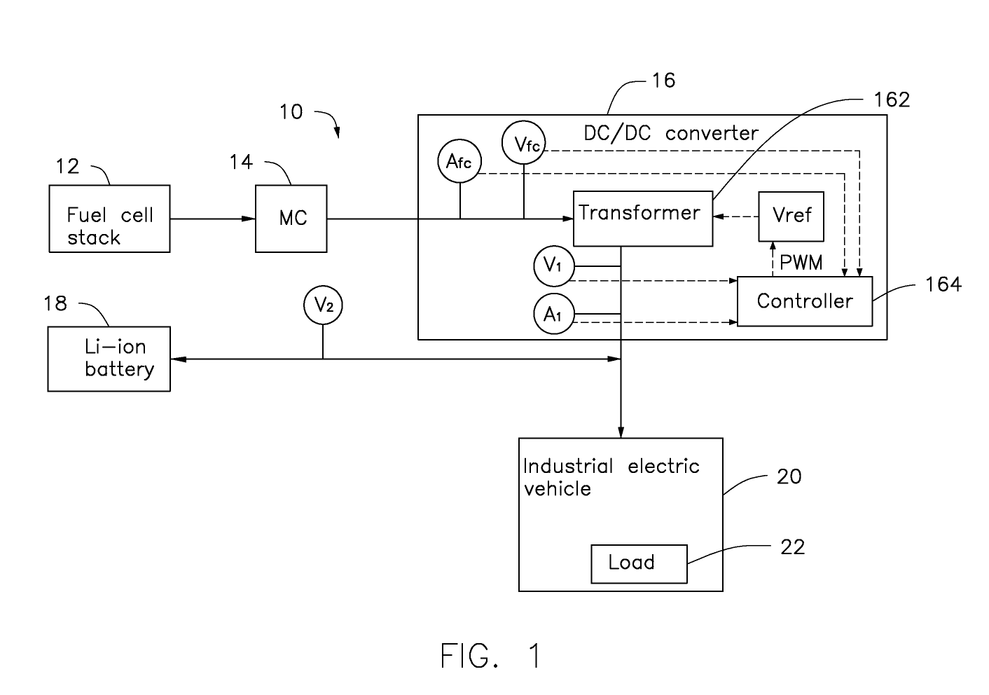

FIG. 1 illustrates a block diagram of a hybrid electrical power system 10 for use in a vehicle 20 which can be an industrial electric vehicle such as a forklift. The system 10 includes a fuel cell stack 12, a magnetic contactor (MC) 14, a direct current/direct current (DC/DC) converter 16, and a Li-ion battery 18. The fuel cell stack 12 is a device that converts the chemical energy from a fuel into electricity through a chemical reaction with oxygen or another oxidizing agent. The fuel in accordance with the preferred embodiment is hydrogen. The magnetic contactor 14 is a switch which controls the electrical connection between the fuel cell stack 12 and the DC/DC converter 16 to protect the fuel cell stack 12 from overloading. The DC/DC converter 16 is used to convert the direct current generated by the fuel cell stack 12 to another direct current which has a stabilized and required voltage for driving the vehicle 20. The Li-ion battery 18 is a rechargeable battery which is used for directly providing electrical power to drive the vehicle 20, in addition to the fuel cell stack 12, when necessary. A load 22, which is a DC/AC motor in accordance with the preferred embodiment, of the vehicle 20 is electrically coupled with the Li-ion battery 18 and the fuel cell stack 12 in parallel. Furthermore, the Li-ion battery 18 is electrically coupled to an output of the DC/DC converter 16.

Li-ion batteries are still quite expensive. In the present disclosure, by hybridizing the Li-ion battery 18 with the fuel cell stack 12, the number of the Li-ion battery 18 could be reduced by providing onboard energy conversion from pressurized hydrogen to electrical energy. The pressurized hydrogen can be re-filled within two minutes, and be converted to electrical energy using the fuel cell stack 12. The fuel cell stack 12 covers the rated power requirement to the vehicle 20, while the Li-ion battery 18 can release some additional power needed by the load 22 of the vehicle 20. The present disclosure can solve the weak points respectively of the fuel cell stack 12 and the Li-ion battery 18, by delivering a hybrid solution to a power generator with a 30 kW peak power and 10 kW rated power requirement for an electric vehicle application.

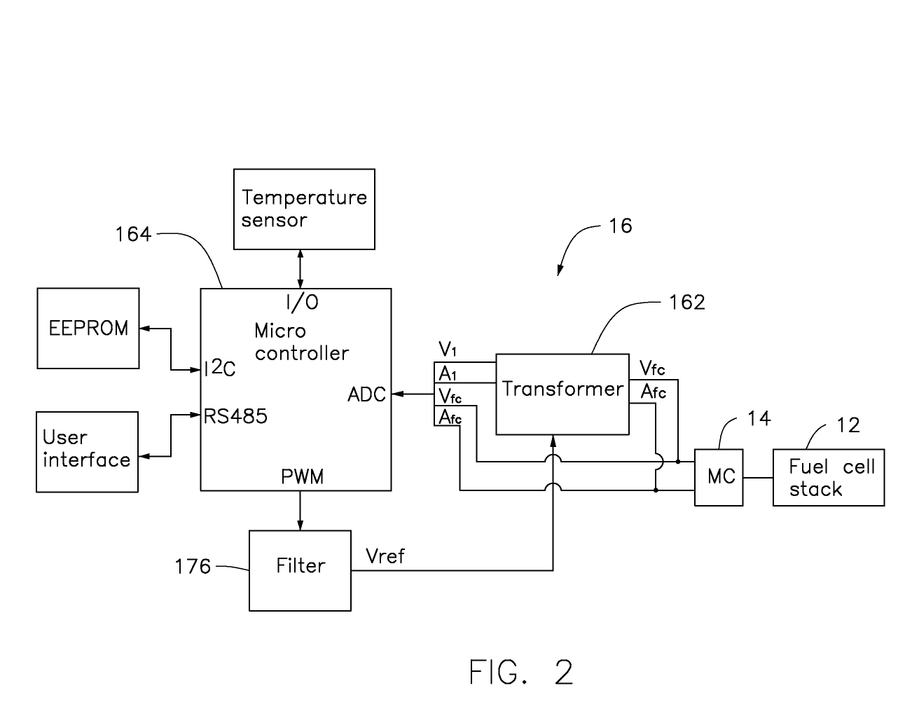

The DC/DC converter 16 comprises a transformer 162 and a controller 164. The transformer 162 is used for transferring the direct current from the fuel cell stack 12 to the another direct current for driving the vehicle 20. The controller 164 is used for setting up a reference voltage V_{ref} that the voltage of the another direct current needs to approach in order to enable the system 10 to have the optimal performance for driving the vehicle 20. Also referring to FIG. 2, the controller 164 can be a micro controller which is in electrical coupling with the transformer 162, the magnetic contactor 14, a filter 176, and other electronic device such as a temperature sensor, an EEPROM and a user interface. Details of the functions of the temperature sensor, the EEPROM and the user interface are omitted here since they are quite well known by those skilled in the art and irrelevant to the claimed scope of the present disclosure. The controller 164 has an analog-to-digital converter (ADC) for receiving analog signals of voltage V_{fc} and current A_{fc} of the direct current from the fuel cell stack 12 and voltage V₁ and current A₁ of the another direct current from the transformer 162 and converting the analog signals into digital signals to be processed by the controller 164 to generate the reference voltage V_{ref}. The controller 164 further comprises a pulse-width modulation (PWM) which is connected with the filter 176 to appropriately output the reference voltage V_{ref} to the transformer 162. The filter 176 is used for filtering noises in the pulse signals of the reference voltage V_{ref} encoded by the pulse-width modulation (PWM) of the controller 164.

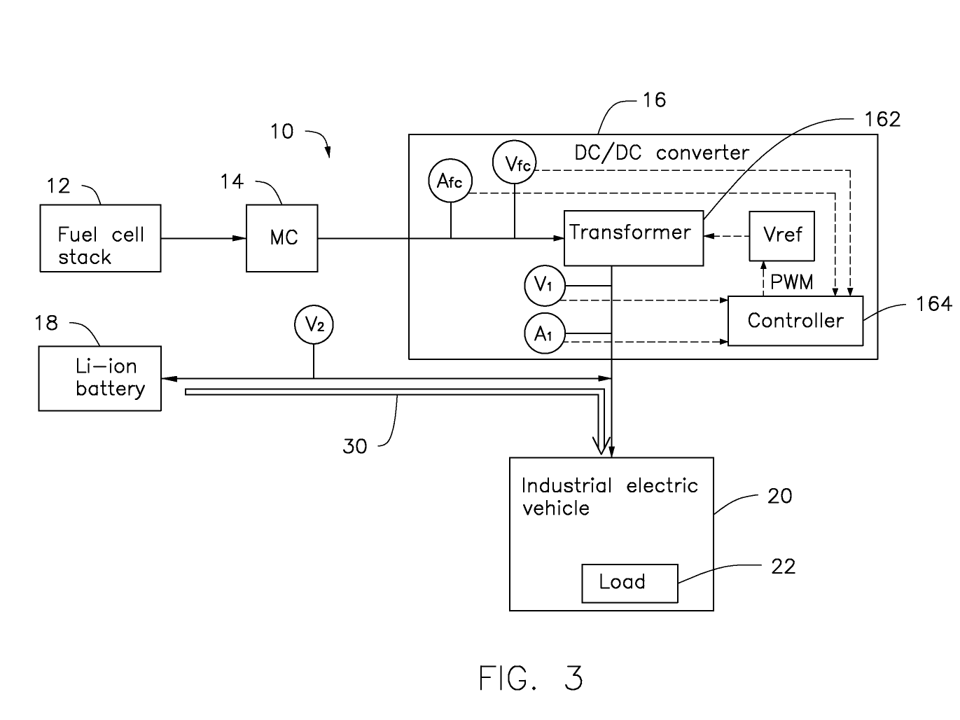

In operation of the system 10, referring to FIG. 3, when the power needed by the load 22 of the vehicle 20 is smaller than a first predetermined value, for example, 1 kW, the fuel cell stack 12 does not output any power to the DC/AC motor of the vehicle 20; only the Li-ion battery 18 outputs power to drive the vehicle 20, as indicated by arrow 30. In this situation, voltage V₂ of direct current from the Li-ion battery 18 is larger than the voltage V₁ of the another direct current generated by the fuel cell stack 12 and converted by the transformer 162 of the DC/DC converter 16.

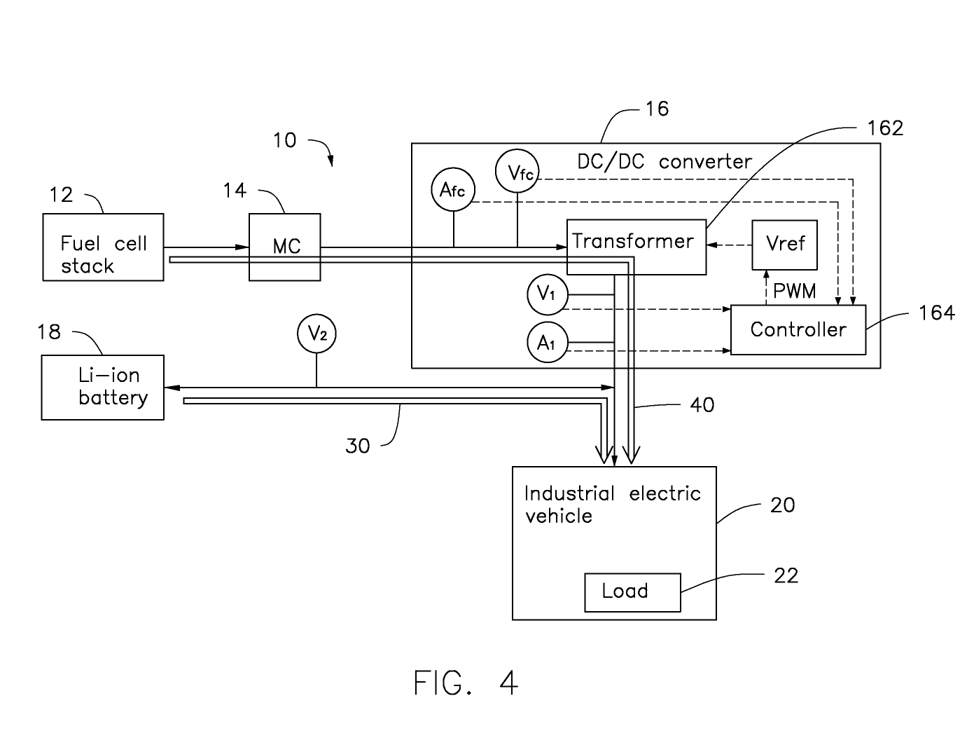

Referring to FIG. 4, when the power needed by the load 22 increases abruptly to a quite large value (i.e., peak load), for example, 20 kW, the Li-ion battery 18 initially still solely provides the required power; then, after a while, when the voltage V₂ of the direct current from the Li-ion battery 18 is lower than the voltage V₁ of the another direct current from transformer 162 of the DC/DC converter 16, the fuel cell stack 12 will provide a large proportion of the required power for driving the vehicle 20, as shown by arrow 40. When the power needed by the load 22 is lowered from the peak load to a level which is still larger than a second predetermined value, for example, 10 kW, the voltage V₁ of the another direct current from the transformer 162 of the DC/DC converter 16 is lowered to enable the Li-ion battery 18 to provide power to the DC/AC motor of the vehicle 20, as indicated by arrow 30. In this situation, the fuel cell stack 12 and the Li-ion battery 18 work together to provide the required power for driving the vehicle 20.

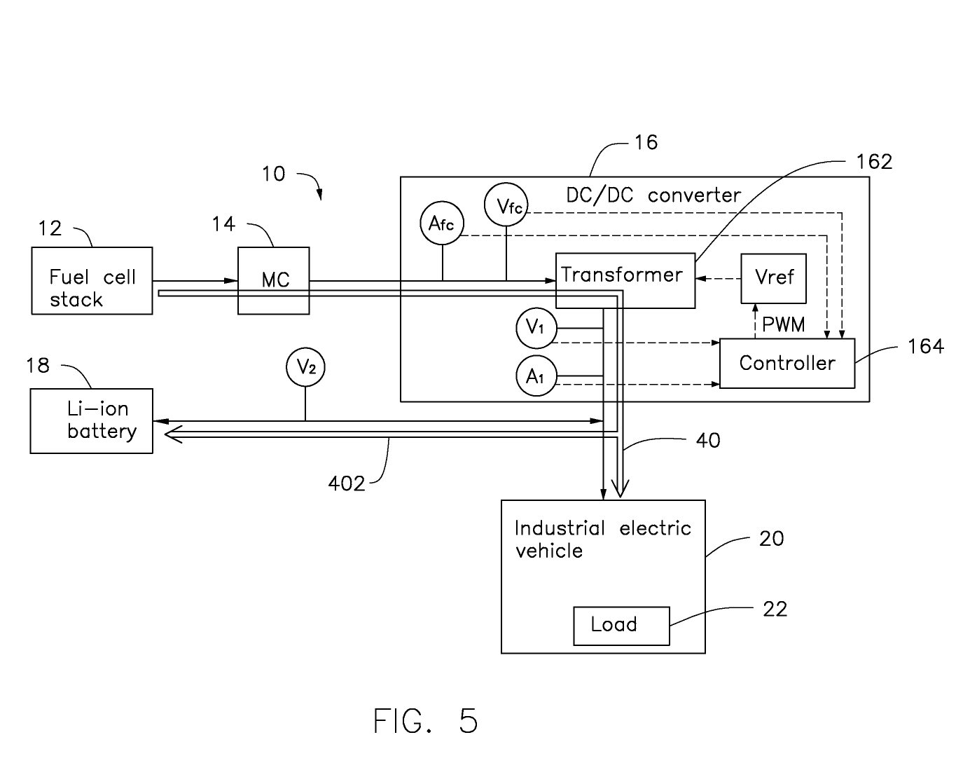

Referring to FIG. 5, when the power needed by the load 22 is gradually lowered to be below the second predetermined value, i.e., 10 kW, since the voltage V₂ of the direct current from the Li-ion battery 18 is lower than the voltage V₁ of the another direct current from transformer 162 of the DC/DC converter 16 and the output from the system 10 does not exceed 10 kW the power needed for satisfying the load 22 is solely provided by the another direct current from the DC/DC converter 40 as indicated by arrow 40. The fuel cell stack 12 solely provides the required power for driving the vehicle 20, and if the fuel cell stack 12 has extra power it can charge the Li-ion battery 18 as indicated by arrow 402.

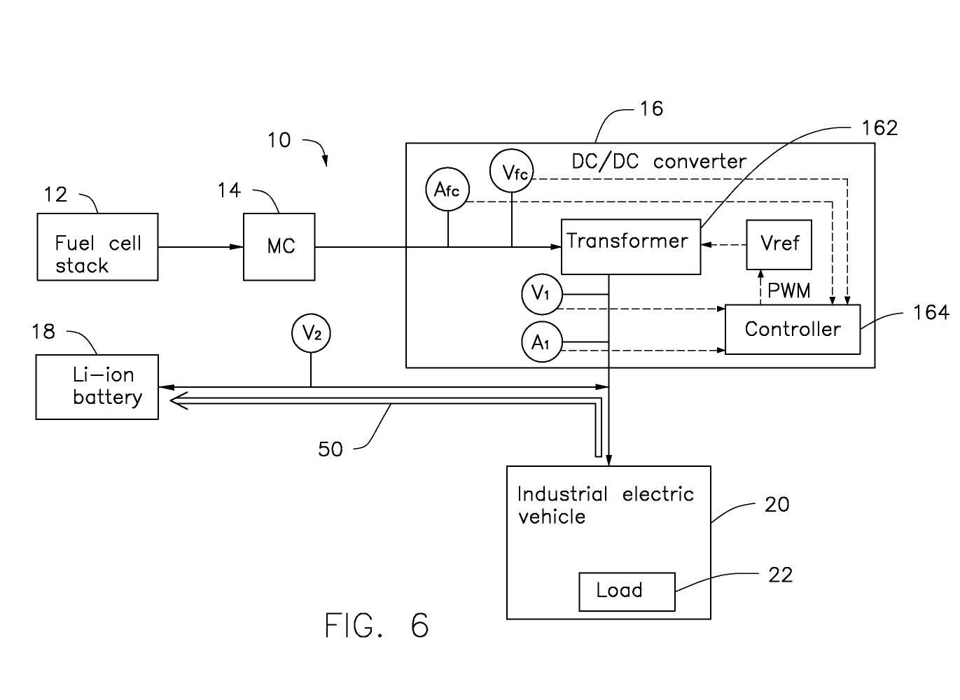

Referring to FIG. 6, when the vehicle 20 brakes to decelerate, the brake is a regenerative brake to enable some of the energy for the braking to flow back to charge the Li-ion battery 18, as indicated by arrow 50. According to the present disclosure, the charging by the fuel cell stack 12 to the Li-ion battery 18 is so controlled that Li-ion battery 18 will not be fully charged, but to a predetermined value. For example, the highest voltage of the another direct current from the DC/DC converter 16 in charging the Li-ion battery 18 can be set with a predetermined value to have Li-ion battery 18 to be at most charged 70%-90% SOC by the fuel cell stack 12. Preferably, the Li-ion battery 18 can be at most charged 80% SOC by the fuel cell stack 12. Accordingly, the Li-ion battery 18 can have a capacity to receive the power generated by the regenerative brake, even if the Li-ion battery 18 has been charged by the fuel-cell stack 12 beforehand.

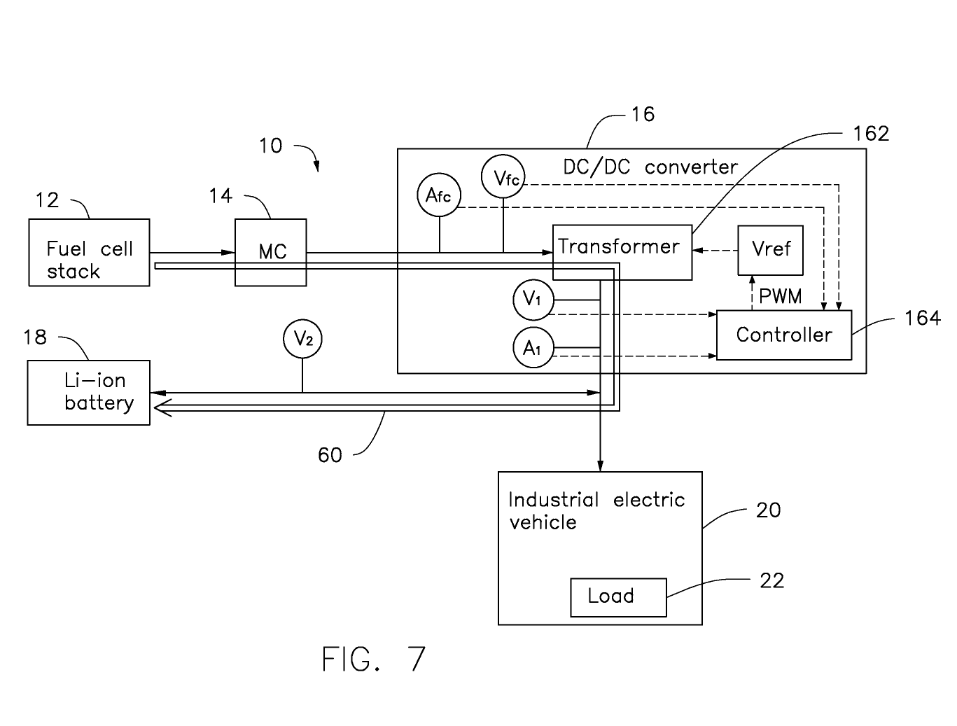

Referring to FIG. 7, when the vehicle 20 stops and the SOC of the Li-ion battery 18 is under the predetermined value, for example, around 80%, the DC/DC converter 16 will regulate the voltage V₁ of the another direct current thereof to charge the Li-ion battery 18 as indicated by arrow 60 until the SOC of the Li-ion battery 18 reaches to a determined storage capacity, such as around 80%.

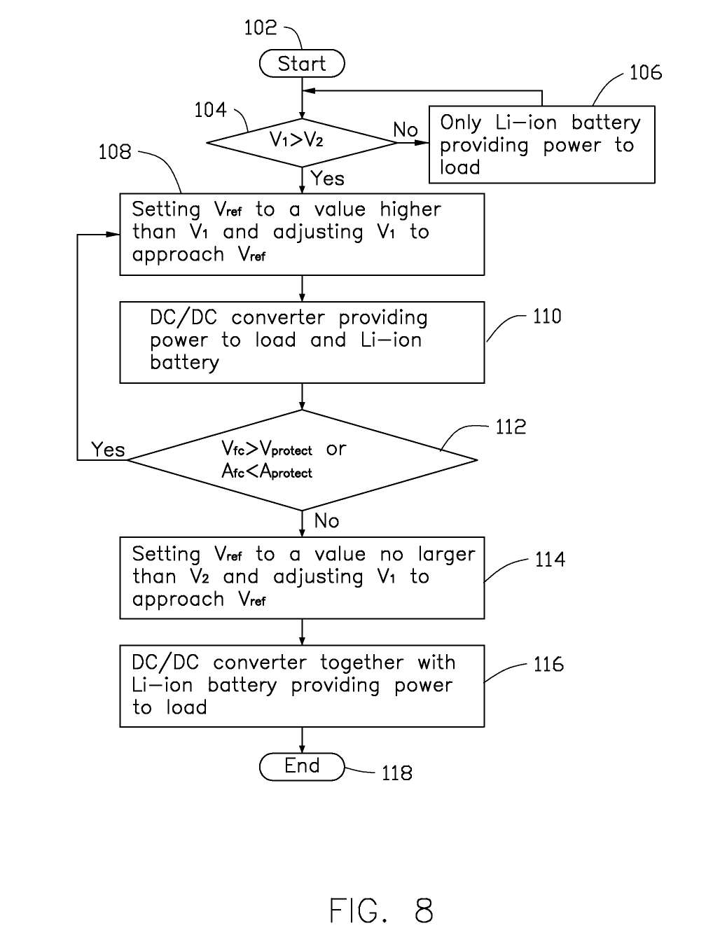

A method 100 of operation of the system 10 is shown in FIG. 8, which begins from block 102, for which an operator/driver ignites and starts the vehicle 20. In block 104, a comparison between the voltage V₁ of the another direct current from the DC/DC converter 16 and the voltage V₂ of the direct current from the Li-ion battery 18 is compared. If V₁ is smaller than V₂, then the method 100 moves to block 106, in which only the electricity from the Li-ion battery is supplied to the load 22 (i.e., DC/AC motor) of the vehicle 20, and then the comparison of block 104 is repeated. The operation of block 106 is correspondent to the operation of FIG. 3. If V₁ is larger than V₂, the method 100 moves to block 108. In block the 108, the voltage V₁ is raised to the reference voltage V_{ref} which is has a first value. For example, when the voltage V₁ is 40 voltages, then the reference voltage V_{ref} can be 41 voltages. The voltage V₁ can be raised to reach the reference voltage V_{ref} by a plurality of algorithms. For example, the voltage V₁ can be incrementally increased to reach the reference voltage V_{ref}. V_{ref}=V1+a*n wherein “a” means the amount of voltage increased each time and “n” means the number of times of increase. For example, “a” can be 0.1 voltage and “n” can be 10.

After the voltage V₁ reaches the reference voltage V_{ref}, in block 110 the fuel cell stack 12 solely provides the required power to the load 22 to drive the vehicle 20 via the DC/DC converter 16. Furthermore, the fuel cell stack 12 provides electricity to charge the Li-ion battery 18 via the DC/DC converter 16. The operation of block 110 corresponds to the operation of FIG. 5.

In block 112, a check is made to decide whether that the voltage V_{fc} of the direct current from the fuel cell stack 12 is larger than a threshold value, V_{protect}, which means a protection voltage of the fuel cell stack 12 that the voltage V_{fc} should not be smaller than, or the current A_{fc} of the direct current from the fuel cell stack 12 is smaller than a threshold value, A_{protect}, which means a protection current of the fuel cell stack 12 that the current A_{fc} should not be larger than. If the answer of the check in block 112 is positive, the method 100 flows back to block 108 to repeat the operations of blocks 108, 110 and 112. If the answer is negative, the method 100 flows to block 114, in which the reference voltage V_{ref} is set to be no larger than the voltage V₂ of the direct current from the Li-ion battery 18. Then the voltage V₁ is lowered to reach the reference voltage V_{ref}. For example, the voltage V₁ is incrementally decreased until it reaches the reference voltage V_{ref}. V_{ref}=V1−b*m, wherein “b” means the amount of voltage decreased each time and “m” means the number of times of decrease.

In block 116, the fuel cell stack 12 stops its charging to the Li-ion battery 18 and only provides electricity to the load 22 to drive the vehicle 20. Moreover, the Li-ion battery 18 also provides electricity to the load 22 to drive the vehicle 20. The operation of block 116 is correspondent to the operation of FIG. 4.

After block 116, if the operator/driver turns off the power, then the method 100 moves to block 118, in which the method 100 ends. Otherwise the method 100 moves back to block 112 to continue the operation therefrom.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A hybrid electrical power system for a vehicle comprising:
a fuel cell stack which generates electricity by a chemical reaction between a fuel and oxygen;
a direct current/direct current (DC/DC) converter in electrical connection with the fuel cell stack for converting a voltage of direct current generated by the fuel cell stack into another voltage of direct current, the DC/DC converter comprising a transformer for performing the voltage conversion and a controller for setting a reference voltage to the transformer for the another voltage to approach, the DC/DC converter having an output configured for electrical connection with an electric motor of the vehicle; and
a rechargeable battery in electrical coupling with the output of the DC/DC converter and configured for electrical connection with the electric motor of the vehicle.

2. The hybrid electrical power system of claim 1, wherein the rechargeable battery is a Li-ion battery.

3. The hybrid electrical power system of claim 2, further comprising a magnetic contactor (MC) between the fuel cell stack and the DC/DC converter for protecting the fuel cell stack from overloading.

4. The hybrid electrical power system of claim 3, wherein the controller generates the reference voltage based on the voltage and current of direct current generated by the fuel cell stack and the another voltage and current of direct current converted by the transformer.

5. The hybrid electrical power system of claim 4, wherein the controller has a PWM (pulse-width modulation) which encodes the reference voltage into pulse signals to be sent into the transformer.

6. The hybrid electrical power system of claim 5, wherein the DC/DC converter further has a filter interconnecting the PWM of the controller and the transformer.

7. The hybrid electrical power system of claim 4, wherein when a voltage of direct current from the Li-ion battery is larger than the another voltage of direct current from the DC/DC converter, only the direct current from the Li-ion battery flows to the electric motor of the vehicle to drive the vehicle.

8. The hybrid electrical power system of claim 7, wherein when the voltage of direct current from the Li-ion battery is smaller than the another voltage of direct current from the DC/DC converter, the reference voltage is set to be larger than the another voltage, and the direct current from the DC/DC converter flows to both the Li-ion battery to charge the Li-ion battery and the electric motor of the vehicle to drive the vehicle.

9. The hybrid electrical power system of claim 8, wherein when the voltage of direct current from the fuel cell stack is smaller than a protection voltage of the fuel cell stack or the current of direct current from the fuel cell stack is larger than a protection current of the fuel cell stack, the reference voltage is set to be no larger than the voltage of direct current from the Li-ion battery and both the electricity of the fuel cell stack and the electricity of the Li-ion battery flow to the electric motor of the vehicle to drive the vehicle.

10. The hybrid electrical power system of claim 4, wherein brake of the vehicle is a regenerative brake which generates electricity to charge the Li-ion battery.

11. The hybrid electrical power system of claim 10, wherein the fuel cell stack is capable of charging the Li-ion battery to a state of charge (SOC) to a predetermined level which is not fully charged in respect to a charging capacity of the Li-ion battery.

12. The hybrid electrical power system of claim 11, wherein the predetermined level of SOC is substantially 80% SOC.

13. The hybrid electrical power system of claim 4, wherein the vehicle is an industrial electric vehicle.

14. The hybrid electrical power system of claim 13, wherein the vehicle is an electric forklift.

15. An electric forklift comprising:
a hybrid electrical power system, comprising:
a fuel cell stack for generating electricity by a chemical reaction between hydrogen and oxygen;
a DC/DC converter in electrical connection with an output of the fuel cell stack, comprising:
a transformer for converting a voltage of direct current from the fuel cell stack into another voltage of direct current; and
a controller for generating a reference voltage for the another voltage to approach, based on the voltage and a current of direct current from the fuel cell stack and the another voltage and a current of direct current converted by the transformer; and
a rechargeable battery; and
at least an electric motor in electrical connection with the transformer and the rechargeable battery;
wherein when a load of the at least an electric motor is above a predetermined value, the fuel cell stack and the rechargeable battery together provide power to drive the at least an electric motor in which the reference voltage is set to be no larger than a voltage of direct current from the rechargeable battery; and
wherein when the load of the at least an electric motor is below the predetermined value, the fuel cell stack provides power to drive the at least an electric motor and charge the rechargeable battery in which the reference voltage is set to be larger than the another voltage of direct current from the transformer.

16. The electric forklift of claim 15, wherein the predetermined value is substantially 10 kW.

17. A method for operating a hybrid electrical power system for an industrial electric vehicle comprising an electric motor, the hybrid electrical power system comprising a fuel cell stack, a DC/DC converter comprising a transformer electrically interconnecting the fuel cell stack and the electric motor and a controller for generating a reference voltage to the transformer and a rechargeable battery in electrical connection with the transformer and the electric motor, the method comprising:
starting the electric motor;
determining whether a first voltage of direct current from the transformer is larger than a second voltage of direct current from the rechargeable battery, wherein when the first voltage is not larger than the second voltage, only the rechargeable battery provides power to drive the electric motor and the judgment is repeated;
adjusting the first voltage to the reference voltage which set to be a third voltage larger than the first voltage when the first voltage is larger than the second voltage;
providing power to drive the electric motor by the fuel cell stack and charging the rechargeable battery by the fuel cell stack;
determining whether a voltage of direct current from the fuel cell stack is large than a protection voltage for the fuel cell stack or a current of direct current from the fuel cell stack is smaller than a protection current for the fuel cell stack, wherein the method moves to the step of adjusting the first voltage to the reference voltage when the voltage of direct current from the fuel cell stack is large than the protection voltage or the current of direct current from the fuel cell stack is smaller than the protection current;
adjusting the first voltage to the reference voltage which is set to be a fourth voltage not larger than the second voltage when the voltage of direct current from the fuel cell stack is not large than the protection voltage or the current of direct current from the fuel cell stack is not smaller than the protection current; and
providing power to drive the electric motor by both the fuel cell stack and the rechargeable battery.

18. The method of claim 17, wherein the rechargeable battery is a Li-ion battery.

19. The method of claim 18, wherein the step of adjusting the first voltage to the third voltage is achieved by incrementally increasing the first voltage until the first voltage reaches the third voltage and the step of adjusting the first voltage to the fourth voltage is achieved by incrementally decreasing the first voltage until the first voltage reaches the fourth voltage.

20. The method of claim 19, wherein the reference voltage is obtained by a pulse-width modulation of the controller based on the voltage and the current of direct current generated by the fuel cell stack and the first voltage and the current of direct current generated by the transformer.

21. A hybrid electrical vehicle power system comprising:
a fuel cell stack, the fuel cell stack electrically generating electricity by chemical reaction between a fuel and an oxidizing agent;
a direct current to direct current (DC/DC) converter having an input and an output with the converter input in electrical connection with the fuel stack to receive an input voltage generated by the fuel stack and the converter output electrically connectable to an electric motor of the vehicle and outputting an output voltage, the converter having a transformer and a controller; and
a rechargeable electrical battery electrically connected to the converter output and electrically connectable to, and providing a battery voltage to, the electric motor of the vehicle;
wherein, the transformer converts the input voltage to the output voltage based on a reference voltage and the controller sets the reference voltage based in part on the battery voltage.
